(19) United States
(12) Patent Application Publication
(10) Pub. No.: US 2007/0015127 A1
(43) Pub. Date: Jan. 18, 2007

(54) Method of mental training

(76) Inventor: Glen Teyf, Brooklyn, NY (US)

Correspondence Address: Steven Horowitz;Counselor At Law, Suite 700, 295 Madison Avenue, New York, NY, 10017, US

(21) Appl. No.: 11/184,219

(22) Filed: Jul. 18, 2005

(51) Int. Cl. G09B 19/00

(52) U.S. Cl. 434/236

(57) ABSTRACT

A method of mental training wherein a human subject receives a hands on treatment containing a unique sequence of strokes, simultaneously receives a message in one ear suggesting that the subject visualize the hands on treatment and simultaneously receives a second message in the other ear communicating a re-educative message.

### FIELD OF THE INVENTION

The field of this invention is mental training, and more particularly, mental training employing a mind and body system.

### BACKGROUND OF THE INVENTION AND DISCUSSION OF THE PRIOR ART

Various forms of mental training are known including subliminal and overt conveying of messages. In the case of messages that are not hostile to the values of the subject, but are positive, although the content of the messages has a large effect on the success of mental training, there is evidence that the state of mind of the human subject also plays a large role in the ability to incorporate the message. While different human subjects have different degrees of suggestibility, human subjects in general can be placed into more relaxed states of mind using various techniques. However, some of these techniques may be unappealing to the human subject who is not looking for invasive or threatening suggestions. Furthermore, not all of these techniques can be applied to human subjects of all kinds and ages.

What is needed is an appealing message conveyed to the human subject that sends the subject into an alpha state of consciousness within a short period of time and keeps the subject there for a long enough time and makes the subject susceptible to a re-educative message.

Massage therapy which operates on the body is known. However, there are many collections of sequences of strokes used to achieve the effect of the therapy. What is needed is a particularly effective sequence of strokes that maximizes the susceptibility of the human subject to a re-educative message.

### SUMMARY OF THE PRESENT INVENTION

The present invention offers a uniquely effective method of mental training for a human subject concerning a particular topic that involves a hands on treatment to relax the body and better absorb the message combined with a relaxation message in one ear that relaxes the body and sends the subject into an alpha state of consciousness. Simultaneous with the above the re-educative message is conveyed to the subject in the other ear.

The hands on treatment is applied in prone position diaper style with a unique sequence of strokes that are applied very slowly with very gentle pressure over approximately fifty minutes.

### IMPORTANT OBJECTS AND ADVANTAGES

The following important objects and advantages of the present invention are:

(1) to provide a method of training the mind concerning particular topics;

(2) to provide such a method that incorporates hands on treatment;

(3) to provide such a method that effects a long-lasting and enduring re-education of the mind;

(4) to provide such a method that relates to weight management;

(5) to provide such a method that relates to sports enhancement;

(6) to provide such a method that relates to stress management;

(7) to provide such a method that incorporates a first message in a first ear and a second message in a second ear;

(8) to provide such a method wherein one message is re-educative and relates to the topic of concern and wherein the second message is relaxative and involves visualizing the hands on treatment;

(9) to provide such a method wherein the hands on treatment involves a particular sequence of strokes;

(10) to provide such a method wherein the strokes used in the hands on treatment are performed very slowly;

(11) to provide such a method wherein the hands on treatment is conducted over a time period of approximately 50 minutes;

(12) to provide such a method wherein the second message in the second ear is intended to put the subject into an alpha state of consciousness;

(13) to provide such a method wherein the hands on treatment is performed with very gentle pressure;

(14) to provide such a method wherein the hands on treatment is performed with the subject in prone position with diaper style draping;

(15) to provide such a method wherein the hands on treatment makes the subject more susceptible to the re-educative message;

(16) to provide such a method wherein a message sent into one ear of the subject sends the subject into an alpha state of consciousness within a relatively short period of time and makes the subject more susceptible to the re-educative message;

(17) to provide such a method wherein the re-educative message in one ear, the relaxative message in the other ear and the hands on treatment are performed totally simultaneously;

(18) to provide such a method wherein the subject is able to concentrate on both the re-educative and the relaxative messages conveyed to two different ears simultaneously because of the subject's relaxed alpha state;

(19) to provide such a method wherein the subject is able to accept both message simultaneously because of the subject's relaxed state;

(20) to provide such a method wherein the re-educative message and the relaxative messages are appealing message that would not make most or almost any human subjects feel threatened or be unwilling to undergo the program;

(21) to provide such a method wherein the method can be carried out on an extremely wide range of human subjects;

(22) to provide such a method wherein the method can be successfully conducted on human subjects of all ages old enough to comprehend the messages;

(23) to provide such a method wherein the relaxative message keeps the subject in an alpha state of consciousness for a long enough amount of time to receive the benefit of the re-educative message.

### DETAILED DESCRIPTION OF THE PREFERRED EMBODIMENT

The method of the present invention will now be illustrated by reference to the accompanying description and examples.

The present invention is a method for mental training of a human subject with respect a specific topic, comprising simultaneously performing steps “(a)”, “(b)” and “(c)”, wherein step (a) comprises performing a hands on treatment on an outside of a body of the subject, the hands on treatment comprising a sequence of hand strokes performed very slowly affecting an extensive collection of muscles of the body and lasting from between approximately thirty minutes to approximately seventy minutes, step (b) comprises positioning an audio device, said audio device continuously dictating a first message, so that the subject hears the first message in a first ear of the subject, the message concerning the topic, and step (c) comprises positioning an audio device, said audio device continuously dictating a second message, so that the subject hears the second message in a second ear of the subject, the second message being a relaxative message capable of placing the subject into an alpha state of consciousness by instructing the subject to visualize the hands on treatment and/or an effect of the hands on treatment.

Examples of topics are weight management, stress management and enhancement of sports performance. Enhancement of sports performance can include enhancing the performance of an amateur or professional athlete at critical situations during the sport. For example, if a tennis player tends to tense up unnecessarily just before swinging, the player can require a program using the method of the present invention that incorporates a message covering the topic of sports enhancement.

The first message and the second message are communicated to the subject by simply having the subject place headphones connected to a speaker on ear, with the first ear receiving the first message and the second ear receiving the second message. While this is the simplest and one preferred embodiment of implementing the steps involving the messages in each ear, it is contemplated by the present invention that other ways may be employed to have the subject hear the first and second message in each ear. Devices other than headphones might be employed, for example. A sound proof room with a speaker not adjacent the ears might be a method used. A chip receiving wireless communication might be employed. The present invention is not limited to particular variations of how the message is conveyed to the subject. The present invention merely dictates that two different messages are conveyed to the subject. Accordingly, if new technology comes into being that somehow allows two different messages to be conveyed through one ear of a human subject, it is even conceivable that such an arrangement could be within the present invention.

The Hands on Treatment

The technical details of the hands on treatment will now be described but it should be understood that the present invention contemplates other sequences of strokes and other manners of conducting the hands on treatment provided such strokes or manner achieves relaxation and sends the subject into an intermediate state of consciousness between conscious state and unconscious or sleep state, said intermediate state being referred to as an alpha state of consciousness.

The hands on treatment is conducted with the subject in prone position, diaper style with the towel in between the legs and covering the back. The level of pressure is very gently. All strokes are to be done very slowly and the entire treatment lasts approximately 50 minutes. To provide the widest possible range, it can be said that the entire length of the treatment lasts between approximately 30 and approximately 70 minutes and most likely between approximately 40 and approximately 60 minutes.

The following is a technical description of the hands on treatment in its ideal form:

Start on the right side of the body

1 Minute

With the client being covered start with your hands on the back. Your hands should be evenly placed across the spine. Hold it until you feel the client has even breathing.

3 Minutes

Put your hands on the head, with all of your fingertips around the axis of the head. Hold your fingertips firmly and slowly bring them up until you reach the top of the head.

(About 90 Seconds)

Repeat to arrive at 3 minutes

2 Minutes

With your finger tips on the side of the head do pick up efflerage to the side of the head repeat 8-10 times

2 Minutes

Remove the sheet and move the towel around the waist, with legs, back and hands being exposed Stand on the right side of the body

Application of Oil or Cream

back and lateral and medial side of right leg
back and lateral and medial side of left leg
all over the back
right hand
left hand
   7 Minutes
   Standing on the right side with your right hand on the right ankle and the left hand on the left ankle
Place your hands on the ankles and slowly efflerage up to the back of the calves, and bring your hands back to the ankles
Place your hands on the ankles and slowly efflerage up to the back of the knees, and bring your hands back to the ankles
Place your hands on the ankles and slowly efflerage up to the back of the hamstrings, and bring your hands back to the ankles
Place your hands on the ankles and slowly efflerage up to the hamstrings and go latterly with your hands around the side of the legs and up until your reach the sacrum and bring your hands back to the ankles
Place your hands on the ankles and slowly efflerage up to the hamstrings and go latterly with your hands around the side of the legs and up until your reach the thoracic vertebras (T12) and bring your hands back to the ankles
Place your hands on the ankles and slowly efflerage up to the hamstrings and go latterly with your hands around the side of the legs and up until your reach the cervical vertebras (C 7) and bring your hands back to the ankles
Place your hands on the ankles and slowly efflerage up to the hamstrings and go latterly with your hands around the side of the legs and up until your reach the shoulders and do pick up efflerage around the shoulders and bring your hands over the arms and back to lateral thighs and bring your hands back to the ankles
Repeat the move above 5-8 times for a total of approximately 7 minutes
   5 Minutes
   Move to the top the bed
   A) Starting at the Occiput
Place your hands with your fingertips on the erector spinae muscles directly lateral to the spine.
Move your finger tips down until your reach the sacrum
Turn your thumb upwards holding your thumbs toward the head and bring up your hands back to the shoulders
When you reach the occiput move your hands over and down the arms until your fingertips touch the finger tips of the patient
Bring your hand back up the arms until your hands reach their starting point
   Repeat 3 times
   B) Starting at the Occiput
Place your hands with your fingertips on the erector spinae muscles directly lateral to the spine.
Move your finger tips down until your reach the sacrum
Move your hands around the lateral side of the back with your hands over the sides of the lower back
Bring your hands around and back at mid thoracic level back next to the spine on the erector spiane muscles and turn your thumb upwards holding your thumbs toward the head and bring up your hands back to the shoulders
When you reach the occiput move your hands over and down the arms until your fingertips touch the finger tips of the patient
Bring your hand back up the arms until your hands reach their starting point
   Repeat 3 times
   Alternate between stroke A and B until your reach 5 minutes
   4 Minutes
   Standing on the left side of the body at clients shoulder level
With your hands in the middle of the left side of the back, use hand over hand efflerage and bring your stroke down to (T12) region and bring your hands back to original position
With your hands in the middle of the left side of the back, use hand over hand efflerage and bring your stroke down to pelvic region and bring your hands back to original position
With your hands in the middle of the left side of the back, use hand over hand efflerage and bring your stroke down to lateral side of the hip region and bring your hands back to original position
With your hands in the middle of the left side of the back, use hand over hand efflerage and bring your stroke down to lateral side of the hip region and towards the back of the knee and bring your hands back to original position
With your hands in the middle of the left side of the back, use hand over hand efflerage and bring your stroke down to lateral side of the hip region and towards the ankle bring your hands back to original position
   Repeat 5 times
   7 Minutes
   Standing on the left side of the body with your hands in on the left ankle using hand over hand efflerage
Place your hands on the ankles and slowly efflerage up to the back of the calves, and bring your hands back to the ankles
Place your hands on the ankles and slowly efflerage up to the back of the knees, and bring your hands back to the ankles
Place your hands on the ankles and slowly efflerage up to the back of the hamstrings, and bring your hands back to the ankles
Place your hands on the ankles and slowly efflerage up to the hamstrings and go latterly with your hands around the side of the legs and up until your reach the sacrum and bring your hands back to the ankles
Place your hands on the ankles and slowly efflerage up to the hamstrings and go latterly with your hands around the side of the legs and up until your reach the thoracic vertebras (T12) and bring your hands back to the ankles
Place your hands on the ankles and slowly efflerage up to the hamstrings and go latterly with your hands around the side of the legs and up until your reach the cervical vertebras (C 7) and bring your hands back to the ankles
Place your hands on the ankles and slowly efflerage up to the hamstrings and go latterly with your hands around the side of the legs and up until your reach the shoulders and do pick up efflerage around the shoulders and bring your hands over the arms and back lateral thighs and bring your hands back to the ankles
Repeat the move above 10-12 times
   5 Minutes
   Move to the top the bed
   A) Starting at the Occiput
Place your hands with your fingertips on the erector spinae muscles directly lateral to the spine.
Move your finger tips down until your reach the sacrum
Turn your thumb upwards holding your thumbs toward the head and bring up your hands back to the shoulders
When you reach the occiput move your hands over and down the arms until your fingertips touch the finger tips of the patient
Bring your hand back up the arms until your hands reach their starting point
   Repeat 3 times
   B) Starting at the Occiput
Place your hands with your fingertips on the erector spinae muscles directly lateral to the spine.
Move your finger tips down until your reach the sacrum
Move your hands around the lateral side of the back with your hands over the sides of the lower back
Bring your hands around and back at mid thoracic level back next to the spine on the erector spinae muscles and turn your thumb upwards holding your thumbs toward the head and bring up your hands back to the shoulders
When you reach the move your hands over and down the arms until your fingertips touch the finger tips of the patient
Bring your hand back up the arms until your hands reach their starting point
   Repeat 3 times
   Alternate between stroke A and B until your reach 5 minutes 4 Minutes
   Standing on right side of the body at clients shoulder level
With your hands in the middle of the right side of the back, use hand over hand efflerage and bring your stroke down to (T12) region and bring your hands back to original position
With your hands in the middle of the right side of the back, use hand over hand efflerage and bring your stroke down to pelvic region and bring your hands back to original position
With your hands in the middle of the right side of the back, use hand over hand efflerage and bring your stroke down to lateral side of the hip region and bring your hands back to original position
With your hands in the middle of the right side of the back, use hand over hand efflerage and bring your stroke down to lateral side of the hip region and towards the back of the knee and bring your hands back to original position
With your hands in the middle of the right side of the back, use hand over hand efflerage and bring your stroke down to lateral side of the hip region and towards the ankle bring your hands back to original position
   7 Minutes
   Standing on right side of the body with your hands in on the left ankle using hands over hand
Place your hands on the ankles and slowly efflerage up to the back of the calves, and bring your hands back to the ankles
Place your hands on the ankles and slowly efflerage up to the back of the knees, and bring your hands back to the ankles
Place your hands on the ankles and slowly efflerage up to the back of the hamstrings, and bring your hands back to the ankles
Place your hands on the ankles and slowly efflerage up to the hamstrings and go latterly with your hands around the side of the legs and up until your reach the sacrum and bring your hands back to the ankles
Place your hands on the ankles and slowly efflerage up to the hamstrings and go latterly with your hands around the side of the legs and up until your reach the thoracic vertebras (Ti2) and bring your hands back to the ankles
Place your hands on the ankles and slowly efflerage up to the hamstrings and go latterly with your hands around the side of the legs and up until your reach the cervical vertebras (C 7) and bring your hands back to the ankles
Place your hands on the ankles and slowly efflerage up to the hamstrings and go latterly with your hands around the side of the legs and up until your reach the shoulders and do pick up efflerage around the shoulders and bring your hands over the arms and back lateral thighs and bring your hands back to the ankles
Repeat the move above 10-12 times
   3 Minutes
   Stand at the head of the client
   With your finger tips on the side of the head do pick up efflerage to the side of the head. Repeat 8-10 times

The Messages

The following is an example of a first message used in connection with the topic of stress management:
As your mind and body being preparing for a trance-formational experience, you can know deep down inside yourself that you possess unique psychological capabilities, capabilities that can help you to make changes in your life, changes that can help you deal the people and situations which cause you stress. And you're probably wondering just how you are going to tap into those capabilities that exist inside yourself, those skills and resources that are stored in your subconscious mind waiting, just waiting to be accessed. Well as you continue listening to the sound of my voice some very interesting things are going to begin to happen inside yourself as the comfort level of your mind and body begins to deepen. And you've probably wondered from time to time what it feels like to go into a deep trance state, to drift down to a place where everything slows, slows way, way down. Down to a place where time feels like slow motion. Now the mind can experience time in various ways. And when things slow down, some very special things can begin to happen inside oneself. And feeling very comfortable is only of them. So as you process the words you are hearing right now you might already be expericing a subtle shift in comfort. And should that be the case feel free let it deepen even more, for only you know just how comfortable and just how deep you want to go always remains with you and as you make that choice for yourself, perhaps you can begin to sense that subtle shifts are beginning to take place all through your mind and body, shifts that allow you to be in a more fluid state, a state that allows far more flexability in you ability to access information and skills that will allow you make some important stress related changes in your life. And you know that part of the reason you are listening right now has to do with stress and how to handle it more productively. Well, stored in your subconscious mind, deep below the surface of awareness is a complete understanding of the mechanisms you've been using to cope with stress. Your subconscious mind know with precision, which people situations and events set into motion a pattern which end up with you storing stress in your back. Well in a few minutes you will be able to create some new patterns, patterns that will allow you to cope in ways you never thought possible, thus allowing your back and neck to stay stress free. And it's all a part of a trance—formational process that is part of the wisdom contained in your mind and body. So as your internal ears continue to listen to the sound of my voice feel free to allow yourself to drift off to the edges of sleep. For there is a magical property in the twilight state, the state in between waking a sleep. It's a state where you can listen with your subconscious mind while your conscious mind can be absorbed in a wonderful dream state. A state where the words that you hear can be translated into changes quickly, effortlessly and spontaneously. NOW I don't know whether you've drifted all the way down there just yet. But if you happen to be in a dream state right feel free to stay there for the REST of this experience, totally absorbed in something that is wonderfully relaxing and visually appealing. And the choice as to what exactly you would like to see will always remain with you for this is your experience and your life and what's more important than your life right now your subconscious mind is listening more closely than ever, and as it does so it can focus in a way that can allow some patterns to be reorganized inside yourself. Neuro—muscular patterns that have been operating outside of awareness in your life for a long time. And now it's time for your subconscious mind to focus in a way that will allow those patterns to change, allow you choice as to how you can respond to a person or an event. And perhaps you can make sure you fully and completely understand what creates most of the stress in your life right now. And your subconscious mind certainly has this information and it is perhaps right now doing something productive with it. And over time things will become clearer and clear providing you with what you need in terms of skills in order to make the important changes in your life. And as you continue to experience the comfort of this deeply relaxed state feel free to feel more confident in your ability to cope with whatever situations your confronted with in a way that allows your body to remain stress free. For right now you are beginning to tap into the most powerful parts of yourself, parts of yourself that can unravel topics for yourself on the psychological level so those pains in your neck will be dealt with appropriately. And only you know what that means for you. And it really does allow one to feel really good about oneself when one makes that kind of productive change in one's life at just the right time, in just the right place or with just the right person. And the nice part about these kind changes is they can occur automatically, effortlessly, and spontaneously for the subconscious mind is very creative in its ability to make changes. It just need a gentle push to get those changes into motion. And maybe right now on that subconscious level you are touching down upon those topics for you that are important which will allow you to release all those old negative patterns replacing them with ones that are healthier and more productive. And your subconscious mind know just how to do that, for stored in the archives of your experience on levels below the surface of awareness are ways of coping and patterns of productive responding that will allow your body to remain pain free, the perfect combination which will lift your mood and your self esteem as well. Now everything you have been listening to is being stored inside yourself multiple levels. So the words you are processing and the meaning these words have are being stored in both your body as well as your mind to insure that you will be make the kinds of changes in your responses to stress that you need to make. For the patterns that were the original cause of the problem were mind and body thinking/feeling problems. Which means that the solutions to those problems will also be mind and body thinking/feeling solutions. And that is why information will stored all through the multiple levels of intelligence inside you so as to insure you begin making the best choices for yourself, at right times, in the right places and with the right people. For you really do have these capabilities within you. Sometimes it's just a matter of being having the right key to open up the lock and release the negative patterns and access the positive ones so that the new thoughts, new feelings, new sensations and new behavior will spontaneously occur in your life, allowing your back to remains stress free. And as your consciousness begins to drift back from that really deep state BACK TO COMFORTABLE light trance state you can feel secure in the knowledge that you have learned a great deal while in this state through that healing combination of sound and touch. So feel free to waking consciousness experiencing your body very differently from 30 minutes ago. For during this brief period of time a wonderful physio-psychological transformational process occurred inside you which has set the healing process into motion.

Purely by way of example, what follows is an example of the text of a second message that is conveyed to the subject through the subject's second ear simultaneous with the application of the first message (the re-educative message) and the hands of treatment. This second message directs the subject to visualize what is happening during the hands on treatment. The particular example provided immediately below is conveyed simultaneously with a re-educative message whose topic is stress management. However, the second message can just as well be used with a totally different re-educative message concerning a different topic (i.e. weight management, sports enhancement, etc.)
It is time just to close your eyes and become aware of your body. Time to become aware of just where you have the pain and just how you translate your everyday stresses into the back pain you experience. So begin to let your focus shift completely to the muscle in your back NOW and notice what they feel like. Are they tight or sore? Let yourself notice the pain and tightness in your muscles. Let your consciousness experience these sensations so you know the starting point for the healing process. For by the end of this session you are going to feel completely differently and the mind and body journey that has begun will teach you some valuable things along the way. So let's begin healing by visualizing the many layers of muscles all through your back. Use your internal eyes to see the muscles in your back. And can you also visualize your stress being trapped in your muscles. And have you ever wondered just how this habit of tensing these back muscles started years ago when you first began experiencing this stress. You probably don't remember just how or when this all started, but it doesn't have to be this way. You have the ability to be deal with stress without tensing these muscles, but you need to learn by reeducating your mind and body in order to do so. For you weren't born with tension in your back and you can learn how to RELEASE IT, learn how to deal with everyday circumstances more productively. For everyday we have to deal with various forms of stress, and our mind and body do the best they can to maintain sense of balance. But sometimes we feel overloaded as we struggle to meet life's everyday demands. And when that happens that stress and tension goes directly to the muscles in your back creating the discomfort that you feel where you hold your stress. But the most important idea you are ever going to hear is that YOU CAN CHANGE THIS. YOU HAVE THE POWER TO CHANGE YOUR MIND AND BODY RESPONSE TO STRESS. YOU HAVE THE ABILITY TO CHANGE THIS OLD HABIT OF HOLDING STRESS IN YOUR BACK AND REEDUCATE YOURSELF using the power of your subconscious mind. And I know your wondering just how this can happen, just how that you cope with stress without pain. Well it will all happen on the subconscious level allowing your conscious mind to be relaxed more of the time. And perhaps right now you can feel your back letting go of the stress and as that happens you might also notice your breathing, the gentle rhythm of this relaxation process. And as you allow yourself to relax feel free to visualize the hands rubbing your back . . . and see the gentle strokes relaxing all these muscles. And with every breath you take and with every stroke your back muscles become stronger and healthier. And as this healing process continues, feel free to BEGING THE MIND AND BODY REEDUCATION PROCESS TO BECOME STRESS FREE. Isn't it a wonderful thought to imagine being stress free and to realize that you have the capabilities of BEING THAT WAY. RIGHT NOW you are learning just how to do that, just how to keep your back stress free. And as your subconscious mind continues its learning process of selecting alternative ways to deal with stress, your conscious mind can use its internal eyes and see the wonderful healing process that is taking place right now. See the blood flowing through the muscles of your back and imagine just how the additional oxygen being supplied to your back by the increased circulation is facilitating this healing process. And this healing process is the first step in the reeducation process so that your back muscles will be healthy and stress free. With every stroke you can visualize your back muscles being detoxified. With every stroke you can see all the toxins leaving your back. With every single massage stroke these toxins are being flushed out of your system via 700 lymph nodes. Your body's healing mechanisms are fully activated and being utilized by the healing hands that are stroking your body right now. And your subconscious mind understands intuitively all of this and is storing this visceral information as part of the learning process so your back remains strong and relaxed when confronted with stress. Right now as you feel the gentle strokes of massage healing and releasing the muscles of your back your subconscious mind is searching for alternative ways of coping. The wisdom contained in your mind and body is healing you on more than one level healing continues, let you internal eyes visualize the muscles in your neck . . . and let yourself feel the gentle strokes unraveling the knots in your neck muscles. And feel free to feel the blood circulating and bringing oxygen to the muscles in your neck. Perhaps, you already notice your neck muscles loosening up and feeling stronger and healthier with each stroke. And your neck can also learn how to stay relaxed more often and remain stress free. For both your back and your neck are part of the same reeducation process of releasing the pain and learning new ways to cope with stress. Your neck and your back can say no more to tension and pain. And now it is time to visualize your upper back and shoulders and see the hands massaging these and gently unraveling the blood circulating through the upper back and shoulders muscles bringing healing oxygen. And as this happens these areas release their stress as well and with each stroke the shoulders and upper back become healthier as the toxins leave these muscles allowing you to feel better quickly and permanently. And your conscious mind is probably aware of just how much more comfortable your shoulders and upper back muscles feel right now. And reeducation process that is occurring on both mind and body levels is establishing pain free patterns for coping with stress so that your shoulders and upper back can move in any way you want. And now you can shift your attention to your lower back and once again feel the power of the gentle strokes unraveling the knots in your lower back. And you internal eyes and see the blood circulating and bringing oxygen to your lower back muscles. And with each stroke your back muscles are becoming stronger and healthier as all the toxins are flushed away and all the stress floats away and the healing wisdom contained in your mind and body remains active allowing the stress release and reeducation process to work its magic quickly and permanently so that your back muscles will never feel this discomfort again. And perhaps you can notice how much better the muscles in your lower back feel right now, how much more relaxed and comfortable they feel, how much stronger they feel and how much better you feel with each and every breath that you take the mind body process, the healing hands that are stroking your body are teaching you what your body feel like, how to release and relax while simultaneously, your subconscious mind has been listening on another level imagining coping mechanisms that you can use so you can keep your back and neck and shoulders, more relaxed and pain free. And doesn't it really feel good to be in touch with your body and be able to be in control of what's happening more of the time. Isn't it nice to know that your muscles are now healthier and stronger. And won't it be wonderful to feel stress free feeling at the end of the session. You have a special mind and body intelligence within you that is being tapped into through the hands that have been stroking you and the words you have been listening to. This unique combination of sound and touch has been teaching you how to be in touch with your body so as not to hold stress in your muscles it is one piece in the process of staying healthy.

In sum, the method of mental training of the present invention comprises simultaneously performing the step of a hands on treatment on an outside of a body of the subject, the hands on treatment comprising a sequence of hand strokes performed very slowly affecting an extensive collection of muscles of the body and lasting from between approximately thirty minutes to approximately seventy minutes, simultaneously conveying a first audio message to the subject in the subject's ear, the first message concerning a topic, and simultaneously conveying a second message to the subject in a second ear of the subject, the second message being a relaxative message capable of placing the subject into an alpha state of consciousness by instructing the subject to visualize the hands on treatment and/or an effect of the hands on treatment.

It is to be understood that while the apparatus of this invention have been described and illustrated in detail, the above-described embodiments are simply illustrative of the principles of the invention. It is to be understood also that various other modifications and changes may be devised by those skilled in the art which will embody the principles of the invention and fall within the spirit and scope thereof. It is not desired to limit the invention to the exact construction and operation shown and described. The spirit and scope of this invention are limited only by the spirit and scope of the following claims.

What is claimed is:

1. A method for mental training of a human subject, said mental training concerning a specific topic, comprising:
simultaneously performing step “(a)”, step “(b)” and step “(c)”,
wherein step (a) comprises performing a hands on treatment on an outside of a body of the subject, the hands on treatment comprising a sequence of hand strokes performed very slowly affecting an extensive collection of muscles of the body and lasting from between approximately thirty minutes to approximately seventy minutes,
wherein step (b) comprises positioning an audio device, said audio device continuously dictating a first message, so that the subject hears the first message in a first ear of the subject, the message concerning the topic, and
wherein step (c) comprises positioning an audio device, said audio device continuously dictating a second message, so that the subject hears the second message in a second ear of the subject, the second message being a relaxative message capable of placing the subject into an alpha state of consciousness by instructing the subject to visualize the hands on treatment and/or an effect of the hands on treatment.

2. The method of claim 1, wherein the topic is weight management.

3. The method of claim 1, wherein the topic is stress management.

4. The method of claim 1, wherein the topic is enhancement of sports performance.

5. The method of claim 1, wherein the sequence of hand strokes of the hands on treatment is performed very slowly, includes efflerage strokes, employs very gentle pressure, and is conducted with the human subject in prone position.

6. The method of claim 5, wherein the sequence of strokes includes performing hands on strokes for approximately one minute on a back of the human subject, approximately three minutes on a head of the human subject, approximately two minutes of efflerage to a side of the head, approximately seven minutes of efflerage on a legs of the human subject, approximately five minutes on the body including on (i) the occupit (ii) the erector spinae muscles (iii) the sacrum, (iv) a shoulders of the body, and (v) arms of the body, approximately four minutes on the back, approximately seven minutes of efflerage on the legs and approximately three minutes of efflerage to a side of the head.

7. The method of claim 1, wherein the hands on treatment last approximately fifty minutes.

8. The method of claim 1, wherein the effect of the hands on treatment is that stress is significantly reduced from the body and/or from particular muscles of the body.

9. A method for mental training of a human subject, said mental training concerning a specific topic, comprising:
simultaneously performing a hands on treatment on an outside of a body of the subject, the hands on treatment comprising a sequence of hand strokes performed very slowly affecting an extensive collection of muscles of the body and lasting from between approximately thirty minutes to approximately seventy minutes, while
simultaneously conveying to the human subject a first message so that the subject hears the first message in a first ear of the subject, the first message concerning the topic, and
simultaneously conveying to the human subject a second message so that the subject hears the second message in a second ear of the subject, the second message being a relaxative message capable of placing the subject into an alpha state of consciousness by instructing the subject to visualize the hands on treatment and/or an effect of the hands on treatment.

10. The method of claim 9, wherein the topic is weight management.

11. The method of claim 9, wherein the topic is stress management.

12. The method of claim 9, wherein the topic is enhancement of sports performance.

13. The method of claim 9, wherein the sequence of hand strokes of the hands on treatment is performed very slowly, includes efflerage strokes, employs very gentle pressure, and is conducted with the human subject in prone position.

14. The method of claim 13, wherein the sequence of strokes includes performing hands on strokes for approximately one minute on a back of the human subject, approximately three minutes on a head of the human subject, approximately two minutes of efflerage to a side of the head, approximately seven minutes of efflerage on a legs of the human subject, approximately five minutes on the body including on (i) the occupit (ii) the erector spinae muscles (iii) the sacrum, (iv) a shoulders of the body, and (v) arms of the body, approximately four minutes on the back, approximately seven minutes of efflerage on the legs and approximately three minutes of efflerage to a side of the head.

15. The method of claim 9, wherein the hands on treatment last approximately fifty minutes.

16. The method of claim 9, wherein the effect of the hands on treatment is that stress is significantly reduced from the body and/or from particular muscles of the body.
